(19) United States
(12) Patent Application Publication
(10) Pub. No.: US 2016/0036961 A1
(43) Pub. Date: Feb. 4, 2016

(54) METHOD FOR CONNECTING CALL WHEN RECEIVED ON MOBILE DEVICE

(71) Applicant: ADESIGN, Seoul (KR)

(72) Inventor: Yong Won LEE, Seongnam-si Gyeonggi-do (KR)

(21) Appl. No.: 14/776,388

(22) PCT Filed: Dec. 24, 2013
(86) PCT No.: PCT/KR2013/012095

§ 371 Date: Sep. 14, 2015

(30) Foreign Application Priority Data
Mar. 15, 2013 (KR) 10-2013-0028018

(51) Int. Cl. H04M 1/725; H04W 4/14; H04W 76/02; H04M 1/27; H04M 1/67

(52) U.S. Cl. CPC H04M 1/72563; H04M 1/271; H04M 1/67; H04W 76/02; H04W 4/14

(57) ABSTRACT

The present invention relates to a method for connecting a call when received on a mobile device and, more specifically, relates to a method for connecting a call when received on a mobile device, wherein, if a call arrives in circumstances under which it is difficult to use a lock function without the free use of both hands, it is possible to connect the call even without using the lock function by converting a user voice signal incoming from a microphone (MIC) of the mobile device into text data and comparing same with stored reference text data and, if there is a match, controlling the mobile device as instructed by an applicable command, so as to either send text or connect the call immediately.

### TECHNICAL FIELD

The present invention relates to a method for connecting a call when a mobile device receives the call, and more particularly to a method for connecting a call such that when a mobile device receives the call under the condition that a lock function is difficult to use due to the impossibility of freely using both hands, a user's voice signal inputted from a microphone (MIC) of the mobile device is converted into text data and is compared with stored reference text data, and then if they are identical to each other, a call connection is immediately made by controlling the mobile device as indicated by a command corresponding to the text or is made by transmitting a message without using the lock function.

### BACKGROUND ART

Recently, with the development of a mobile communication network and the development of the specification of a terminal, a mobile communication terminal has become an essential belonging of modem people with departing from a conventional simple communication device or an information providing device, and is evolving into a total entertainment device. Also, the rapid development of the communication technology extends the capability of the terminal. Accordingly, various user interfaces (UIs) and functions using the same are being provided.

Particularly, a terminal equipped with a touch screen sets a variety of locking/unlocking functions in order to limit unnecessary input errors in a standby mode. In a common terminal, for the purpose of unlocking the lock mode (touch screen hold state), the lock mode is unlocked by inputting a predefined password or a password defined by user's setting, or by using a separate key for unlocking the lock mode. That is, the lock set means that a user sets in advance a password having a predetermined number of digits (e.g., 4 digit number) for a menu, for example, call originating, call receiving, message receiving box check, wireless internet access, etc., and the user selects the menu and inputs the predetermined password, and only when the two passwords match each other, the user is allowed to normally use the terminal.

FIGS. 1 and 2 are flowcharts for describing a conventional method for unlocking the lock of the mobile device. As shown in FIG. 1, in the past, in a case where a mobile device is locked (S101), when a user inputs a digit password through a keypad (S102), the mobile device checks whether the digit password match the user-predetermined password or not (S103). If the inputted password matches the user-predetermined password, the lock of the mobile device is unlocked, so that the user is able to use the device (S104).

As shown in FIG. 2, in the past, when the user intends to use the mobile device, the user stores a particular pattern “P” by inputting a particular pattern “P” through touching a liquid crystal display in advance (S201). Then, the pattern “P” which has been inputted by touching the liquid crystal display is sensed by a touch sensor (S202), and a pattern recognizer recognizes information on the input pattern “P” (S203). A pattern comparator compares whether or not the information on the input pattern “P” is the same as information on the pattern predetermined by the user (S204). When the user touches the liquid crystal display 101 and inputs the pattern which matches the pattern predetermined in the mobile device 100, the lock is unlocked such that only authorized users are allowed to use the mobile device 100, so that personal information, etc., stored in the mobile device 100 can be protected (S206).

However, in the conventional technology, the user always has to input a digit password having any number of digits or to touch and input a particular pattern so as to use the mobile device. Also, when the mobile device receives a call under the condition that none of both hands are free, for example, at the time of driving or holding luggage with one hand, the lock cannot be unlocked and the call connection is not made, so that the user is reluctant to use the lock function.

Also, with the launch of a mobile phone capable of supporting a voice dialing, the mobile phone is divided into a mobile phone which can support the voice dialing and a mobile phone which cannot. Regarding the mobile phone which can support the voice dialing, a user stores a phone number to which the user wants to apply the voice dialing in a phone number memory, and then stores a user's starting voice for calling the stored phone number in the mobile phone.

However, the conventional technology is usable for transmitting a call by the mobile phone and is not usable for receiving a call by the mobile phone. Therefore, a user who urgently needs a call connection when the mobile phone receives a call under an unexpected condition avoids the mobile phone to which the conventional technology has been applied.

### DISCLOSURE

### Technical Problem

The present invention is designed to solve the problems of the conventional technology and has an object to provide a method for connecting a call such that when a mobile device receives the call under the condition that a lock function is difficult to use due to the impossibility of freely using both hands, a user's voice signal inputted from a microphone (MIC) of the mobile device is converted into text data and is compared with stored reference text data, and then if they are identical to each other, a call connection is immediately made by controlling the mobile device as indicated by a command corresponding to the text or is made by transmitting a message without using the lock function.

Also, the present invention provides a method for connecting a call when a mobile device receives the call, which stores various similar reference text data and matches for the purpose of increasing the probability of correctly recognizing the voice of the receiver, thereby reducing the recognition error caused by incorrect pronunciation of the user or much noise and reducing the conversion error in conversion of the voice signal into the text.

### Technical Solution

In order to accomplish the objective of the present invention, a method for connecting a call when a mobile device receives the call is provided. The method includes: a first step in which, when a call connection is received by the mobile device, a controller of the mobile device notifies a user through a ringtone or vibration that a call receiving is made; a second step in which, when a voice signal of the user is inputted from a microphone (MIC) of the mobile device, the controller of the mobile device stores the voice signal of the user in a database; a third step in which the controller converts the inputted voice signal into text data, and compares and matches to reference text data stored in the database, and then recognizes the voice signal; a fourth step in which, when the inputted voice signal is successfully recognized, the controller selects a command of a category to which the reference text data or similar text data which is identical to the text data of the inputted voice signal belongs; a fifth step in which, when the selected command is “immediate call”, the controller switches to a call state through the call connection, and then transmits the stored voice signal to the sender; and a sixth step in which, when the selected command is “text transmission”, the controller disconnects the call connection and transmits the sender a transmission text of a category to which the reference text data or similar text data belongs.

### Advantageous Effects

According to the present invention, in a method for connecting a call when a mobile device receives the call, a user's voice signal inputted from a microphone (MIC) of the mobile device is converted into text data and is compared with stored reference text data, and then if they are identical to each other, a call connection is immediately made by controlling the mobile device as indicated by a command corresponding to the text or is made by transmitting a message without using the lock function.

Also, the present invention provides a method for connecting a call when a mobile device receives the call, which stores various similar reference text data and matches for the purpose of increasing the probability of correctly recognizing the voice of the receiver, thereby reducing the recognition error caused by incorrect pronunciation of the user or much noise and reducing the conversion error in conversion of the voice signal into the text.

### DESCRIPTION OF DRAWINGS

FIG. 1 is a flowchart for describing a conventional method for unlocking the lock of a mobile device;

FIG. 2 is a flowchart for describing a conventional method for unlocking the lock of the mobile device; FIG. 3 is a flowchart showing each of steps of connecting a call when the mobile device receives the call in accordance with an embodiment of the present invention;

FIG. 4 is a flowchart showing each of steps of recognizing a voice in the mobile device in accordance with the embodiment of the present invention;

FIG. 5 is a view showing a data structure in the mobile device in accordance with the embodiment of the present invention; and

FIG. 6 is a view showing a data structure in the mobile device in accordance with the embodiment of the present invention.

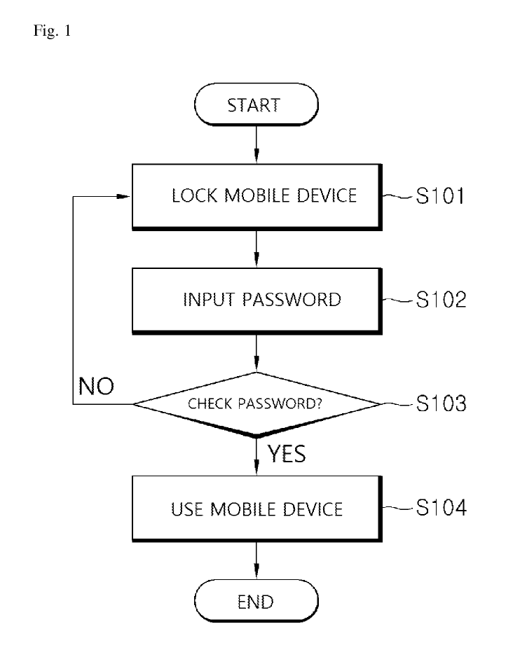

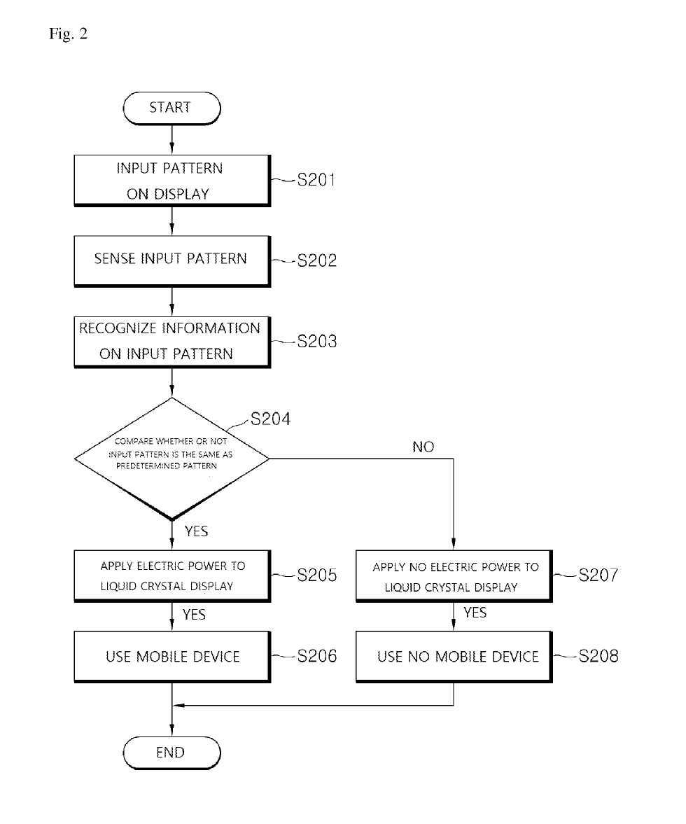

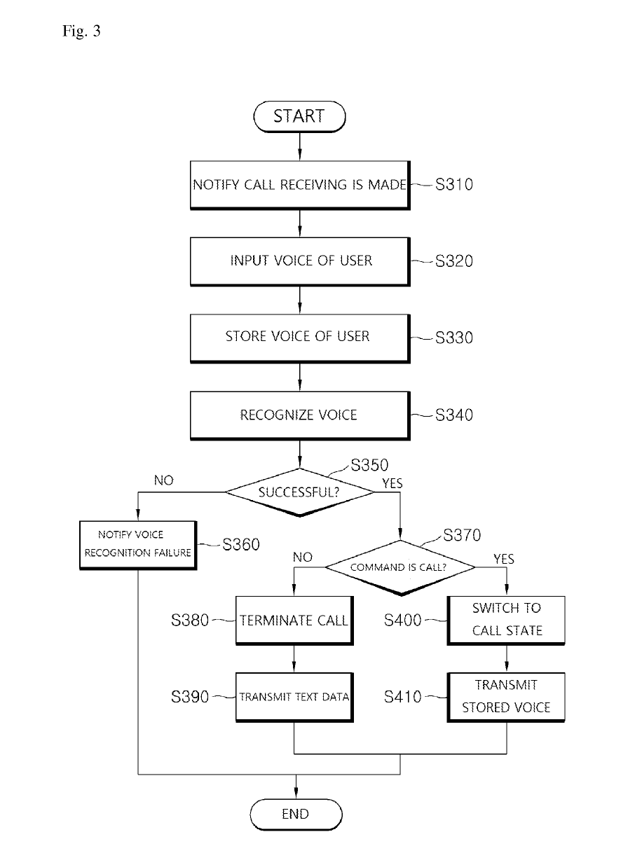

### MODE FOR INVENTION

FIG. 3 is a flowchart showing each of steps of connecting a call when a mobile device receives the call in accordance with an embodiment of the present invention;

When the mobile device receives a call connection, a controller of the mobile device notifies a user through a ringtone or vibration that a call receiving is made (S310). When a voice signal of the user is inputted from a microphone (MIC) of the mobile device (S320), the controller of the mobile device stores the voice signal of the user in a database (S330). When the voice signal of the user is determined as that the user desires to talk, the stored voice signal of the user is transmitted to another user who has made the call, so that the talk is naturally made.

The inputted voice signal is converted into text data by the controller and is compared and matched to reference text data stored in the database, and then the voice signal is recognized (S340). The voice signals which are expected to be inputted by the user when the call connection is received are stored in the form of a variety of reference text data in the database. In order to increase the probability of correctly recognizing the voice, various text data similar to the reference text data are stored together in advance.

When there exist the reference text data and similar text data which are identical to the text data of the inputted voice signal, a command of a category to which the reference text data or similar text data which is identical to the text data of the inputted voice signal belongs is selected (S350). There are two kinds of commands: “immediate call” and “text transmission”. If the reference text data and similar text data which are identical to the text data of the inputted voice signal do not exist, the controller notifies the user of voice recognition failure, and then switches to the standby mode in such a manner the voice can be inputted again (S360).

When the selected command is “immediate call”, the controller switches to a call state through the call connection (S400), and then transmits the stored voice signal to the sender (S410).

When the selected command is “text transmission”, the controller terminates the call by disconnecting the call connection (S380), and then transmits the sender a transmission text of a category to which the reference text data or similar text data belongs (S390).

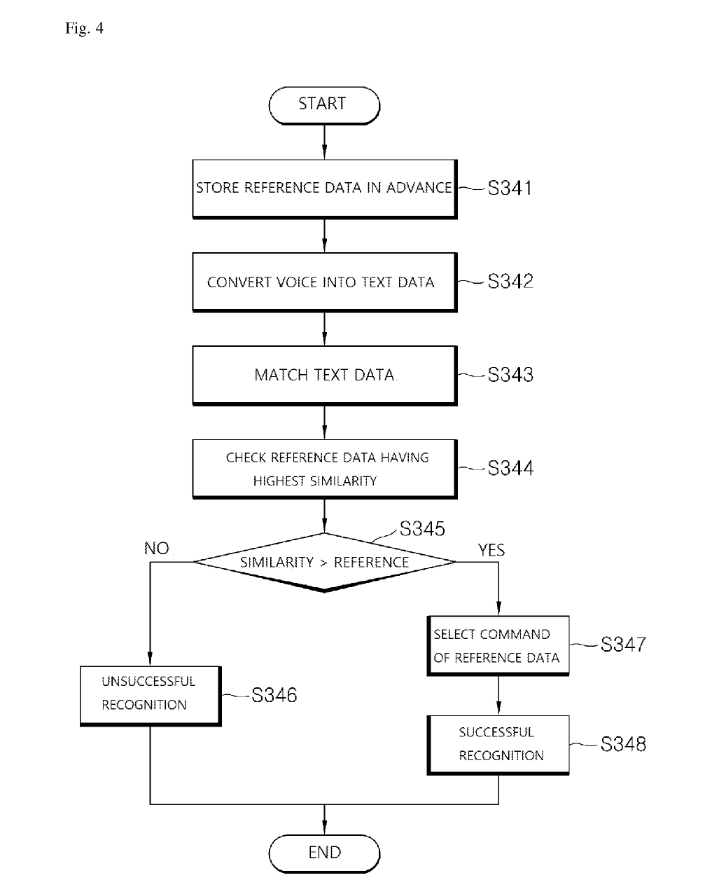

FIG. 4 is a flowchart showing each of steps of recognizing a voice in the mobile device in accordance with the embodiment of the present invention.

The controller of the mobile device stores the voice signals which are expected to be inputted by the user when the call connection is received in the form of a variety of reference text data in the database. In order to increase the probability of correctly recognizing the voice, various text data similar to the reference text data are stored together in advance (S341).

The controller of the mobile device converts the inputted voice signal into the text data (S342), and recognizes the voice signal by comparing and matching with the reference text data or similar text data stored in the database (S343). The matching is performed by two methods, i.e., a one-to-one matching and a similarity matching. Regarding the one-to-one matching, it is checked whether or not there exists the reference text data or similar text data matching the converted text data, and when the reference text data or similar text data matching the converted text data does exist, it is determined that the voice signal is successfully recognized (S347), and when the reference text data or similar text data matching the converted text data does not exist, it is determined that the voice signal recognition is unsuccessful (S345). Regarding the similarity matching, after a similarity between the converted text data and either the reference text data or similar text data is assessed, the reference text data or similar text data which has the highest similarity is selected. When the highest similarity of the selected reference text data or similar text data exceeds a reference value, it is determined that the voice signal is successfully recognized (S347), and when the highest similarity of the selected reference text data or similar text data is less than the reference value, it is determined that the voice signal recognition is unsuccessful (S345).

When the matching is performed successfully, a command of a category of the selected the reference text data or similar text data is selected (S346). The command is transmitted to the controller, and the controller controls the mobile device in accordance with the command.

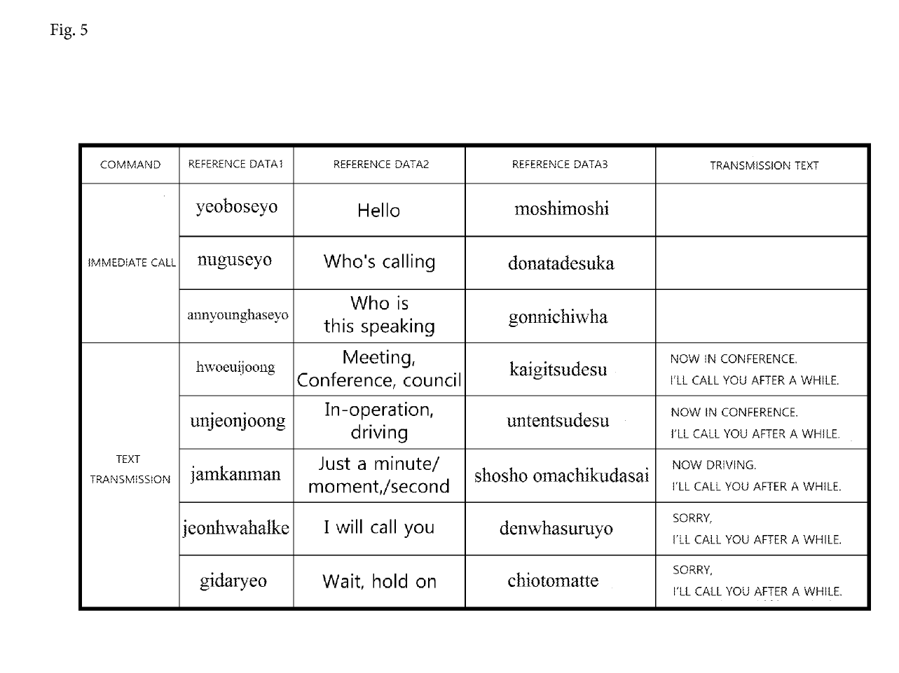

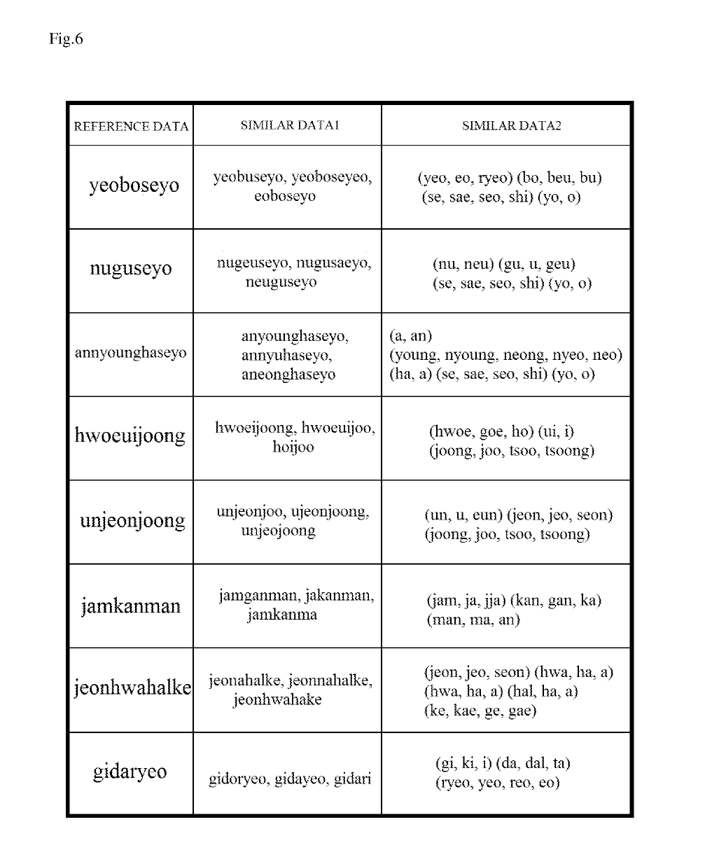

FIGS. 5 and 6 are views showing a data structure in the mobile device in accordance with the embodiment of the present invention.

Referring to FIG. 5, examples of the voice signal of the user are stored in the form of the reference text data and are classified into English and Japanese according to each country's language environment. The related commands are classified in the reference text data. For example, when “hello” is inputted as the voice signal of the user, a command of “immediate call” is transmitted to the controller. Also, when “in conference” is inputted as the voice signal of the user, a command of “text transmission” is transmitted to the controller. When the command is “text transmission”, a text to be transmitted is stored according to the reference text data. For example, when “in conference” is inputted as the voice signal of the user and the command of “text transmission” is transmitted to the controller, a text “Now in conference, I'll call you after a while” to be transmitted is transmitted.

Referring to FIG. 6, similar text data are stored for each reference text data. When the voice signal of the user is recognized or converted into the text data, the recognition error and conversion error do exist. Therefore, in order to minimize the errors, the similar text data are expanded and stored for each reference text data. The similar text data may be divided into a word-type similar text data and a character-type similar text data. The word-type similar text data includes text data related to the word recognition error and conversion errors, which occur the most frequently. The character-type similar text data includes text data related to the recognition error and text error for each character. For example, “hello” may be incorrectly recognized as “hallo” or “hollow”, etc., by user's voice tone and intonation or may be incorrectly converted into a text, and “hel” of “hello” may be incorrectly recognized as “hal”, “hol”, “hul”, etc., or may be incorrectly converted into a text. Therefore, by using this similar text data, it is possible to minimize the recognition error and conversion error.

While the embodiment of the present invention has been described with reference to the accompanying drawings, it can be understood by those skilled in the art that the present invention can be embodied in other specific forms without departing from its spirit or essential characteristics. Therefore, the foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1. A method for connecting a call when a mobile device receives the call, the method comprising:
a first step in which, when a call connection is received by the mobile device, a controller of the mobile device notifies a user through a ringtone or vibration that a call receiving is made;
a second step in which, when a voice signal of the user is inputted from a microphone (MIC) of the mobile device, the controller of the mobile device stores the voice signal of the user in a database;
a third step in which the controller converts the inputted voice signal into text data, and compares and matches to reference text data stored in the database, and then recognizes the voice signal;
a fourth step in which, when the inputted voice signal is successfully recognized, the controller selects a command of a category to which the reference text data or similar text data which is identical to the text data of the inputted voice signal belongs;
a fifth step in which, when the selected command is “immediate call”, the controller switches to a call state through the call connection, and then transmits the stored voice signal to the sender; and
a sixth step in which, when the selected command is “text transmission”, the controller disconnects the call connection and transmits the sender a transmission text of a category to which the reference text data or similar text data belongs.

2. The method of claim 1, further comprising a seventh step in which, when the reference text data and similar text data which are identical to the text data of the inputted voice signal do not exist, the controller notifies the user of voice recognition failure, and then switches to a standby mode in such a manner the voice is inputted again.

3. The method of claim 1, wherein the third step comprises a third-1 step in which the controller converts the inputted voice signal into the text data; a third-2 step in which the controller checks whether or not there exists the reference text data or similar text data matching the converted text data; and a third-3 step in which, when the reference text data or similar text data matching the converted text data does exist, the controller determines that the voice signal is successfully recognized, and when the reference text data or similar text data matching the converted text data does not exist, the controller determines that the voice signal recognition is unsuccessful.

4. The method of claim 1, wherein the third step comprises a third-1 step in which the controller converts the inputted voice signal into the text data; a third-2 step in which the controller assesses a similarity between the converted text data and either the reference text data or similar text data; a third-3 step in which the controller selects the reference text data or similar text data which has a highest similarity; and a third-4 step in which, when the highest similarity of the selected reference text data or similar text data exceeds a reference value, the controller determines that the voice signal is successfully recognized, and when the highest similarity of the selected reference text data or similar text data is less than the reference value, the controller determines that the voice signal recognition is unsuccessful.

5. The method of claim 1, wherein the similar text data comprises a word-type similar text data and a character-type similar text data.

6. The method of claim 2, wherein the third step comprises a third-1 step in which the controller converts the inputted voice signal into the text data; a third-2 step in which the controller checks whether or not there exists the reference text data or similar text data matching the converted text data; and a third-3 step in which, when the reference text data or similar text data matching the converted text data does exist, the controller determines that the voice signal is successfully recognized, and when the reference text data or similar text data matching the converted text data does not exist, the controller determines that the voice signal recognition is unsuccessful.

7. The method of claim 2, wherein the third step comprises a third-1 step in which the controller converts the inputted voice signal into the text data; a third-2 step in which the controller assesses a similarity between the converted text data and either the reference text data or similar text data; a third-3 step in which the controller selects the reference text data or similar text data which has a highest similarity; and a third-4 step in which, when the highest similarity of the selected reference text data or similar text data exceeds a reference value, the controller determines that the voice signal is successfully recognized, and when the highest similarity of the selected reference text data or similar text data is less than the reference value, the controller determines that the voice signal recognition is unsuccessful.

8. The method of claim 2, wherein the similar text data comprises a word-type similar text data and a character-type similar text data.
